(19) United States
(12) Patent Application Publication
(10) Pub. No.: US 2025/0360955 A1
(43) Pub. Date: Nov. 27, 2025

(54) BALL CART SYSTEM

(71) Applicants: Tony Chang, M.D., Redding, CA (US); Karissa Chang, Redding, CA (US); Kaleo Chang, Redding, CA (US)

(72) Inventors: Tony Chang, M.D., Redding, CA (US); Karissa Chang, Redding, CA (US); Kaleo Chang, Redding, CA (US)

(21) Appl. No.: 18/671,303

(22) Filed: May 22, 2024

(51) Int. Cl. B62B 3/04; B62B 3/10

(52) U.S. Cl. CPC B62B 3/04; B62B 3/10; B62B 2202/40; B62B 2203/74

(57) ABSTRACT

A ball cart system includes a cart having a plurality of support rods, a container mounted to the plurality of support rods, the plurality of support rods being configured to support the container, a plurality of springs, at least one spring of the plurality of springs being coupled to an end of at least one of the plurality of support rods, a plurality of rollers, at least one roller of the plurality of rollers being coupled to at least one spring of the plurality of springs, and a ball collector having a cylindrical drum. The container is substantially airtight, and each spring is configured to compress or decompress according to a vertical force applied onto the spring by a weight within the container, and as the weight within the container changes, a height of the container relative to a ground automatically adjusts.

### TECHNICAL FIELD

This disclosure relates generally to a ball cart system.

### BACKGROUND

Tennis is a popular sport played by millions of people each year. Tennis players of all levels often take tennis lessons from tennis instructors. To provide efficient instruction, tennis instructors often use a relatively large number of tennis balls to provide lessons. Tennis balls can be stored in a standard ball cart, which can hold hundreds of tennis balls. When using a standard ball cart, tennis instructors typically stand next to the ball cart and reach inside using one hand to obtain a tennis ball, and, using a tennis racquet held in the other hand, “feed” balls to students. The height of a standard ball cart relative to the ground is not adjustable and will be the same no matter how tall a tennis instructor is or how many balls are in the ball cart. Tennis instructors often teach tennis for many hours a day and repeat the motion of reaching for a tennis ball inside a ball cart thousands of times a day. When the ball cart is full, a tennis instructor does not need to reach far into the cart to obtain a tennis ball. However, as the number of tennis balls in the ball cart decreases, a tennis instructor must reach further and further, and rotate and bend from the hips, waist, and back more and more, to reach tennis balls in the ball cart. This repetitive motion of reaching into a ball cart to obtain tennis balls can lead to pain or injury. A ball cart system that is adjustable and could prevent a tennis instructor from having to reach far inside a ball cart to obtain tennis balls would be desirable.

After the tennis instructor feeds all the tennis balls out of a ball cart, it is necessary to pick up the tennis balls and put them back into the ball cart. Tennis balls are often scattered all over the tennis court, and the tennis instructor (and students) must bend over or kneel to pick up each tennis ball. Done repetitively, this too can lead to pain or injury. Tools exist for picking up tennis balls such as ball mowers, hoppers, and roller collectors. However, these tools are separate from a ball cart and are often bulky and hard to maneuver. A ball cart system that integrates a mechanism for picking up tennis balls would be desirable.

As mentioned above, tennis instructors often use a relatively large number of tennis balls to teach students. Tennis balls are typically pressurized. That is, they have a hollow core filled with pressurized gas that improves the ability for the tennis balls to bounce. Pressurized tennis balls are commonly sold in sealed, airtight cans that are pressurized to match the internal pressure of the tennis balls to prolong their life by preventing the pressurized gas inside the tennis balls from leaking out. However, once the tennis ball can is opened and the pressurized tennis balls are exposed to atmospheric pressure, the gas inside the tennis balls slowly begins to leak and eventually the tennis balls lose pressure and go “dead.” Tennis balls can be purchased at various price points depending on quality and brand name. Because tennis instructors use so many tennis balls, the cost of replacing “dead” tennis balls over time is quite expensive. A ball cart system that helps prolong the life of tennis balls would be desirable.

### BRIEF SUMMARY

Aspects of the disclosure provide a ball cart system including a cart having a plurality of support rods, a container mounted to the plurality of support rods, the plurality of support rods being configured to support the container, a plurality of springs, at least one spring of the plurality of springs being coupled to an end of one of the plurality of support rods, and a plurality of rollers, at least one roller of the plurality of rollers being coupled to at least one spring of the plurality of springs. The ball cart system further includes a ball collector having a cylindrical drum. The container is substantially airtight. Each spring is configured to compress or decompress according to a vertical force applied onto the spring by a weight within the container, and as the weight within the container changes, a height of the container relative to a ground automatically adjusts.

Another aspect of the disclosure is to provide a ball cart system including a cart having a plurality of support rods, a container mounted to the plurality of support rods, the plurality of support rods being configured to support the container, a plurality of rollers, at least one roller of the plurality of rollers being coupled to at least one support rod of the plurality of support rods, a plurality of springs positioned at a bottom of the container, and a movable platform provided inside the container and supported by the plurality of springs. The ball cart system further includes a ball collector having a cylindrical drum. The container is substantially airtight. The plurality of springs are configured to compress or decompress according to a vertical force applied onto the movable platform, and as the vertical force applied onto the movable platform changes, a height of the movable platform relative to a ground automatically adjusts.

Additional features, advantages, and embodiments of the disclosure are set forth or apparent from consideration of the following detailed description, drawings and claims. Moreover, it is to be understood that both the foregoing summary of the disclosure and the following detailed description are exemplary and intended to provide further explanation without limiting the scope of the invention as claimed.

### BRIEF DESCRIPTION OF THE DRAWINGS

FIG. 1 is a perspective view of a ball cart system having a plurality of springs provided at ends of a plurality of rods supporting a container of the ball cart system, according to various embodiments.

FIG. 2 is a perspective view of a ball cart system having a platform supported by a plurality of springs inside a container of the ball cart system, according to various embodiments.

FIG. 3 is a perspective view of a ball cart system including a ball collector, according to various embodiments.

FIG. 4 is a perspective view of a ball cart system having a ball collector and a sealed container, according to various embodiments.

FIG. 5 is a perspective view of a ball cart system having a sealed container, according to various embodiments.

FIG. 6 is a perspective view of a ball cart system having a ball collector, according to various embodiments.

FIG. 7 is a perspective view of a ball cart system having a ball collector and a sealed container, according to various embodiments.

FIG. 8A is a perspective view of a ball cart system having a ball collector and a sealed container, according to various embodiments.

FIG. 8B is a perspective view of a ball cart system having a ball collector and a movable front skirt wall, according to various embodiments.

FIG. 8C is a perspective view of a ball cart system having a removable container, according to various embodiments.

### DETAILED DESCRIPTION

While the ball cart system of this disclosure is described in the context of tennis, it can be used in the context of other sports or activities requiring or benefiting from the advantages of a ball cart system. By way of example and not by limitation, the ball cart system described herein can be used in the context of pickleball, padel, racquetball, or other sports.

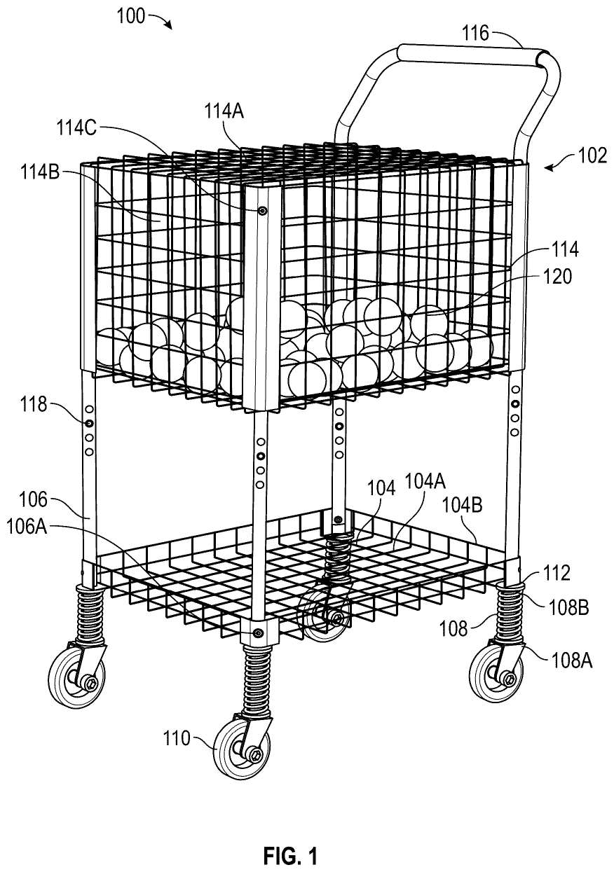

FIG. 1 is a perspective view of a ball cart system 100, according to various embodiments. The ball cart system 100 includes a cart 102. The cart 102 includes a base 104 and a container 114. The base 104 is generally positioned horizontally and parallel to the ground. As shown in FIG. 1, the base 104 can be constructed from a wire mesh 104A or have a wire mesh structure. The base 104 may include a lip or barrier 104B so that the base 104 can more securely hold items (e.g., tennis balls, rackets, cones, etc.). The wire mesh 104A can be a metallic wire mesh, a plastic wire mesh, or the like. Although the base 104 is shown in FIG. 1 as having a wire mesh structure 104A, the base 104 can be constructed from a solid material such as metal (e.g., aluminum) or plastic and can be a plain sheet of material (e.g., a plain sheet of metal or a plain sheet of plastic, etc.) with or without holes.

The cart 102 includes a plurality of support rods 106. The plurality of support rods 106 can be made of any material such as metal or plastic. As shown in FIG. 1, four support rods 106 are used, one connected to each corner of base 104. The base 104 can be soldered, welded, or fastened to the plurality of support rods 106 using one or more fasteners 106A. As shown in FIG. 1, the cart 102 may include a plurality of springs 108 provided at the ends of support rods 106 and above a plurality of wheels or rollers 110. First ends 108A of the springs 108 are coupled to the rollers 110. Second ends 108B of the springs 108 abut stop elements 112. The plurality of springs 108 are configured and arranged to compress or decompress according to a vertical force applied onto them, as will be described in detail in the following paragraphs. The springs 108 can be any kind of springs known in the art, including but not limited to coil springs, leaf springs, air springs, or the like, and each of springs 108 can be of any length. The springs 108 also do not need to be positioned at the ends of support rods 106 but can be positioned anywhere along support rods 106 (and in this case support rods 106 would comprise two different sections). Furthermore, each of the springs 108 can be independently adjustable using dials or knobs to increase or decrease their spring rate. Spring rate is the amount of force it takes to compress a spring by a certain distance. The spring rate can be a function of wire diameter, coil diameter, material, and/or number of active coils. For example, by twisting a dial within the spring, the number of active coils available for deflection can be altered which in turn changes the spring rate.

The rollers 110 are configured to be in contact to the ground as so to allow the cart 102 to roll on the ground. Each roller can include a locking mechanism known in the art to prevent the roller from rolling. Although four rollers 110 are shown in FIG. 1, two rollers 110 can be used as described below. The rollers 110 can be made of any material such as plastic or rubber. The cart 102 may also include a handlebar 116. The handlebar 116 may be coupled to two of the plurality of support rods 106 or to the container 114. Fasteners can be used to couple the handlebar 116 to the plurality of support rods 106, or the handlebar 116 can be soldered or welded. The handlebar 116 is configured to be gripped by one or both hands of a user to push or pull the cart 102 using the plurality of rollers 110 (e.g., four rollers). Where only two rollers 110 are used, the two rollers 110 may be coupled to the springs 108 closest to the handlebar 116. The two opposite springs 108 would not be coupled to rollers. In this case, in order to move the cart 102, a user first tilts the cart 102 using the handlebar 116 so as to move the front end of cart 102 off the ground and in this manner the user can roll the cart 102 using the two rollers 110 that are in contact with the ground.

The container 114 is mounted to the support rods 106, which support the container 114. The container 114 can be a wire mesh basket but is not limited to a wire mesh basket. The container 114 can be constructed from any material (e.g., metal, plastic, wood, or any combination thereof) and can be solid sheets of material or include holes to see through to the contents of the container 114 (e.g., a solid-wall container). The container 114 does not need to be rectangular in shape and can be any shape, such a square, cylindrical, or spherical. The container 114 can be coupled to the support rods 106 using one or more fasteners 114C or can be soldered or welded.

As shown in FIG. 1, container 114 can be provided with a lid 114A. The lid 114A can be hinged to facilitate opening and closing. Although the lid 114A of container 114 is shown being provided at a top side of container 114, the lid 114A can also be provided in any lateral wall 114B of the container 114.

The height of container 114 relative to the ground can also be adjusted through a plurality of height adjusting features 118 provided in the plurality of support rods 106 to hold the container 114 at a desired height. As shown in FIG. 1, the plurality of height adjusting features 118 can include the use of holes and a push button mechanism provided in the support rods 106. The support rods 106 may have a telescoping mechanism such that a first portion of a support rod 108 can be configured to slide relative to a second portion of the support rod 106. A user can push a button on the first portion of a support rod 108 and when the support rod 106 is telescoped to a desired length, the button is released into one of the holes in the second portion of the support rod 106. Instead of a push button mechanism, the plurality of height adjusting features 118 can utilize other mechanisms such as twist locks, flip locks, pins instead of buttons, or the like.

The container 114 is configured to hold a plurality of balls 120 (e.g., tennis balls, pickleballs, etc.). A weight of the plurality of balls 120 inside container 114 exerts vertical forces which in turn compresses the springs 108.

In operation, the container 114 contains a first number (N1) of the plurality of balls 120 having a first total weight (W1). The first total weight (W1) exerts a force on the support rods 106 which in turn compresses the springs 108 to a first length (L1). As a result, the container 114 is at a first height (H1) relative to the ground. However, after taking a certain number of balls (e.g., one or more balls) out of the container 114, a number of the plurality of balls 120 in the container 114 decreases to a second number (N2) with a total weight (W2) less than the first weight (W1). The total weight (W2) exerts less force which in turn decompresses the springs 108 to a second length (L2). The second length (L2) is greater than the first length (L1). As a result, the container 114 shifts up to a second height (H2) relative to the ground. Because the second length (L2) of the spring 112 is greater than the initial first length (L1) of the spring 112, the second height (H2) of the container 114 relative the ground is greater than the first height (H1) of the container 114 relative to the ground.

Initially, when the container 114 contains the first number (N1) of the plurality balls 120 having the first total weight (W1), the number (N1) of the plurality of balls 120 is at a certain first level (V1) relative to the bottom of container 114. However, when the number of the plurality of balls 120 is decreased to the second number (N2), the second number (N2) of the plurality of balls 120 may decrease to a second level (V2) relative to the bottom of container 114. The second level (V2) of the plurality of balls 120 is generally less than the first level (V1) of the plurality of balls 120 relative to the bottom of container 114.

A height of the plurality of balls 120 relative to the ground is equal to a sum of the level of the plurality of balls 120 relative to the bottom of container 114 and the height of container 114 relative to the ground. Therefore, initially, a first height (HG1) of the plurality of balls 120 relative to the ground is equal to a sum of the first level (V1) of the plurality of balls 120 relative to the bottom of container 114 and the first height (H1) of container 114 relative to the ground, (HG1=V1+H1). Similarly, after taking a certain number of balls from the container 114, a second height (HG2) of the plurality of balls 120 relative to the ground is equal to a sum of the second level (V2) of the plurality of balls 120 relative to the bottom of container 114 and the second height (H2) of container 114 relative to the ground, (HG2=V2+H2).

As discussed in the above paragraphs, the second level (V2) of the plurality of balls 120 relative to the bottom of container 114 is less than the first level (V1) of the plurality of balls 120 relative to the bottom of the container 114. However, on the other hand, the second height (H2) of container 114 relative the ground is greater than the first height (H1) of container 114 relative to the ground. An increase in height (from H1 to H2) of container 114 relative to the ground compensates for a decrease in level (from V1 to V2) of the plurality of balls within container 114. As a result, the second height (HG2) of the plurality of balls 120 relative to the ground remains substantially similar (or as close as possible) as the second height (HG1) of the plurality of balls 120 relative to the ground. Therefore, as the level of the plurality of balls 120 changes within container 114, the height of container 114 automatically adjusts so that the plurality of balls 120 are maintained at essentially a similar height (or as close as possible) from the ground due to the adjustment of height of the container 114 made possible by the springs 108. This automatic adjustment can go on until the springs 108 reach their maximum extension length. By maintaining the plurality of balls 120 as close as possible to the same height regardless of the level of the plurality of balls 120 in container 114, a user does not need to bend over as far or reach as far to obtain balls from container 114 as the level of the plurality of balls 120 changes within container 114, which reduces strain on the user.

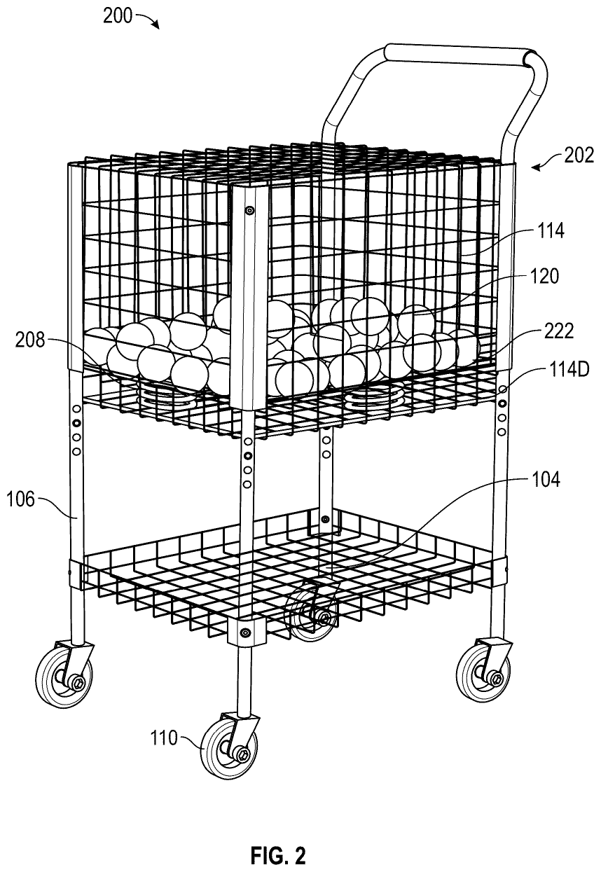

FIG. 2 is a perspective view of a ball cart system 200, according to various embodiments. The ball cart system 200 includes a cart 202. The cart 202 is the same or similar in many aspects to the cart 102 shown in FIG. 1. Therefore, same or similar features will not be further described herein.

One distinction between the cart 202 and the cart 102 is that the cart 202 does not have a plurality of springs 108 provided at the ends of support rods 106. Instead, the support rods 106 extend past the base 104, and the rollers 110 are coupled to the ends of support rods 106. Furthermore, a plurality of springs 208 are provided within the container 114 of the cart 202. Springs 208 are positioned and distributed at a bottom 114D of the container 114. The cart 202 also includes a movable platform 222 provided inside container 114 and supported by the springs 208. The movable platform 222 is movable vertically within container 114. Therefore, the springs 208 are in contact with the bottom 114D of container 114 and with the movable platform 222. Springs 208 can be any kind of springs known in the art, including but not limited to coil springs, leaf springs, air springs, or the like, and each of springs 208 can be of any length. Furthermore, each of the springs 208 can be independently adjustable using dials or knobs to increase or decrease their spring rate similar to the springs 108.

The container 114 is configured to hold the plurality of balls 120 (e.g., tennis balls, pickleballs, etc.). The plurality of balls 120 are disposed on the movable platform 222. A weight of the plurality of balls 120 inside container 114 exerts vertical force onto the movable platform 222 which in turn compresses the springs 208 provided between the movable platform 222 and the bottom 114D of container 114.

In operation, container 114 contains a first number (N1) of the plurality balls 120 having a first total weight (W1). The first total weight (W1) exerts a force on the movable platform 222 which in turn compresses the springs 208 to a first length (L1). As a result, the movable platform 222 is at a first height (H1) relative to the ground. However, after removing a certain number of balls (one or more balls), a number of the plurality of balls 120 decreases to a second number (N2) with a total weight (W2) less than the first weight (W1). The total weight (W2) exerts less force on the movable platform 222 which in turn decompresses the springs 208 to a second length (L2). The second length (L2) is greater than the first length (L1). As a result, the movable platform 222 shifts up to a second height (H2) relative to the ground. Because the second length (L2) of the springs 208 is greater than the initial first length (L1) of the springs 208, the second height (H2) of the movable platform 222 relative the ground is greater than the first height (H1) of the movable platform 222 relative to the ground.

Initially, when container 114 contains the first number (N1) of the plurality balls 120 having the first total weight (W1), the number (N1) of the plurality of balls 120 is at a certain first level (V1) relative to the bottom of container 114. However, when the number of the plurality of balls 120 is decreased to the second number (N2), the second number (N2) of the plurality of balls 120 decreases to a second level (V2) relative to the bottom of container 114. The second level (V2) of the plurality of balls 120 relative to the bottom of container 114 is less than the first level (V1) of the plurality of balls 120 relative to the bottom of container 114.

A height of the plurality of balls 120 relative to the ground is equal to a sum of the level of the plurality of balls 120 relative to the bottom of container 114 and the height of the movable platform 222 relative to the ground. Therefore, initially, a first height (HG1) of the plurality of balls 120 relative to the ground is equal to a sum of the first level (V1) of the plurality of balls 120 relative to the bottom of container 114 and the first height (H1) of the movable platform 222 relative to the ground, (HG1=V1+H1). Similarly, after taking a certain number of balls from container 114, a second height (HG2) of the plurality of balls 120 relative to the ground is equal to a sum of the second level (V2) of the plurality of balls 120 relative to the bottom of container 114 and the second height (H2) of the movable platform 222 relative to the ground, (HG2=V2+H2).

As discussed in the above paragraphs, the second level (V2) of the plurality of balls 120 relative to the bottom of container 114 is less than the first level (V1) of the plurality of balls 120 relative to the bottom of container 114. However, on the other hand, the second height (H2) of the movable platform 222 relative the ground is greater than the first height (H1) of the movable platform 222 relative to the ground. An increase in height (from H1 to H2) of the movable platform 222 relative to the ground compensates for a decrease in level (from V1 to V2) of the plurality of balls 120 within container 114. As a result, the second height (HG2) of the plurality of balls 120 relative to the ground remains substantially similar (or as close as possible) as the second height (HG1) of the plurality of balls 120 relative to the ground. Therefore, as the level of the plurality of balls 120 changes within container 114, the height of container 114 automatically adjusts so that the plurality of balls 120 are maintained at a similar height (or as close as possible) from the ground due to the adjustment of height of the container 114 made possible by the springs 208. This automatic adjustment can go on until the springs 208 reach their maximum extension length. By maintaining the plurality of balls 120 as close as possible to the same height regardless of the level of the plurality of balls 120 in container 114, a user does not need to bend over as far or reach as far to obtain balls from container 114 as the level of the plurality of balls 120 changes within container 114, which reduces strain on the user.

It should be noted that although the embodiment shown in FIG. 2 does not include springs 108 provided at the ends of support rods 106, a ball cart system could also include springs 108, as described with respect to FIG. 1, in addition to springs 208, as described with respect to FIG. 2.

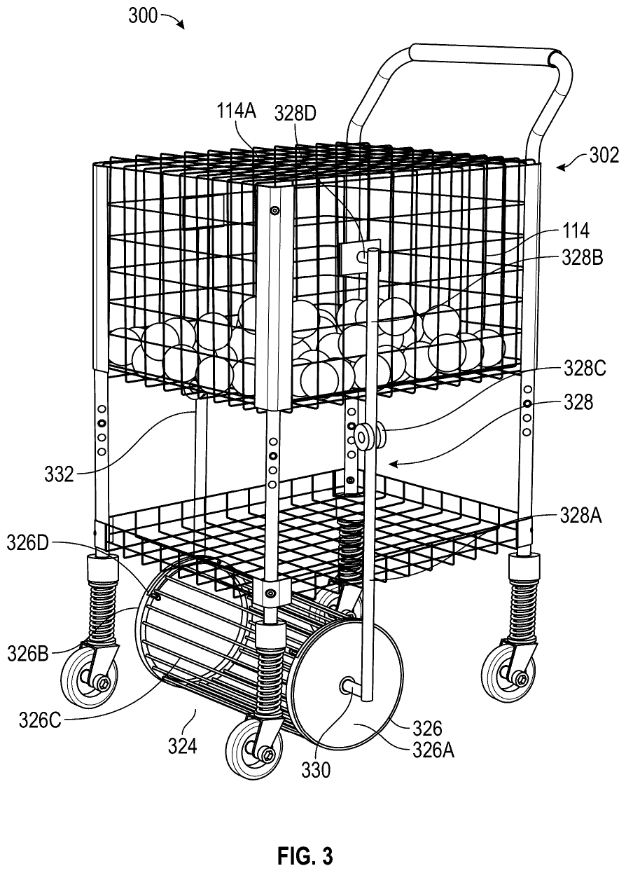

FIG. 3 is a perspective view of a ball cart system 300, according to various embodiments. The ball cart system 300 includes a cart 302 that is the same or similar in many aspects to the cart 102 shown in FIG. 1.

As shown in FIG. 3, a ball collector 324 is coupled to cart 302. The ball collector 324 is configured to collect balls (e.g., tennis ball, pickleballs, etc.) from a playing surface such as a tennis court. The ball collector 324 includes a cylindrical drum 326. The cylindrical drum 326 is configured to rotate around an axis of rotation 330. The cylindrical drum 326 has end sections 326A and 326B which function as wheels to support rolling across the ground surface. End sections 326A and 326B can be configured to swivel to promote turning when being rolled across the ground surface. The cylindrical drum 326 has a plurality of rods 326C. The plurality of rods 326C extend between the end sections 326A and 326B.

The plurality of rods 326C are circumferentially spaced such that a cylindrical space, approximately the same diameter as the end sections 326A and 326B, is defined axially between the end sections 326A and 326B. The plurality of rods 326C are spaced apart around a circumference of the end sections 326A and 326B of the cylindrical drum 326. The amount of space between each of the rods 326C may depend on the type and diameter of balls to be picked up. For example, tennis balls are smaller in diameter than pickleballs and may require slightly less space between each of the rods 326C. The plurality of rods 326C are configured to engage one or more balls (e.g., one or more tennis balls) by applying a downward force, due to gravity and any additional force applied by the operator, on the one or more balls (not shown). The plurality of rods 326C can be made from any material (e.g., metal or plastic) that is somewhat flexible so as to allow the plurality of rods 326C to deform under mechanical stress. The one or more balls and/or two or more adjacent rods in the plurality of rods 326C deform to allow the one or more balls to pass between the two or more adjacent rods in the plurality of rods 326C. For example, one ball would pass between two adjacent rods in the plurality of rods 326C, and another ball would pass between another two adjacent rods in the plurality of rods 326C as the cylindrical drum 326 is rolled across the ground surface.

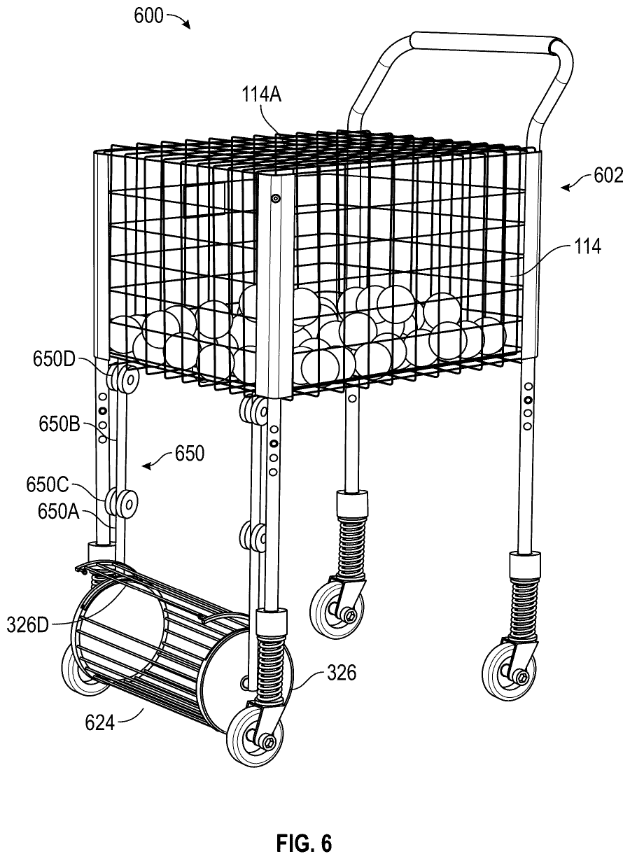

After passing through adjacent rods, the one or more balls returns to their free state. Alternatively, or additionally, the two adjacent rods in the plurality of rods 326C return to their initial state. As a result, the one or more balls remain within the cylindrical space defined by the end sections 326A and 326B, and the plurality of rods 326C. In an embodiment, one or both end sections 326A or 326B can be configured to be removable to allow retrieval of collected balls inside the cylindrical drum 326. Alternatively, the cylindrical drum 326 may include a door 326D connected via hinges to the end sections 326A and 326B or to one of the plurality of rods 326C. Door 326D can be opened, as shown in FIG. 6, to allow retrieval of collected balls inside the cylindrical drum 326.

The cylindrical drum 326 of the ball collector 324 is generally disposed under the cart 302 and can be operated to collect balls when a user is rolling the cart 302. As shown in FIG. 3, the ball collector 324 includes connecting arm 328. The connecting arm 328 includes a first connecting rod 328A and a second connecting rod 328B connected to each other via a rotating joint 328C. The first connecting arm 328A is also connected to the axis of rotation 330 of the cylindrical drum 326. The second connecting rod 328B is also connected to the container 114 via a connector 328D. The connector 328D may be rotatable. A support arm 332 is connected to the opposite end section 326B of the cylindrical drum 326 to support the ball collector 324 when in operation.

In operation, a user can empty balls collected in the cylindrical drum 326 of the ball collector 324 by opening lid 114A if it is closed, detaching support arm 332 from the cylindrical drum 326, pulling the cylindrical drum 326 from under the cart 302 by rotating the first rotating joint 328C, and rotating the connector 328D to bring the cylindrical drum 326 toward the top of the container 114 to empty collected balls into the container 114. It should be appreciated that the arms and rotating connectors are not limited to the above-described configurations. Other arm configurations and rotating connector configurations can be used to enable moving the cylindrical drum 326 to empty the balls collected therein into the container 114.

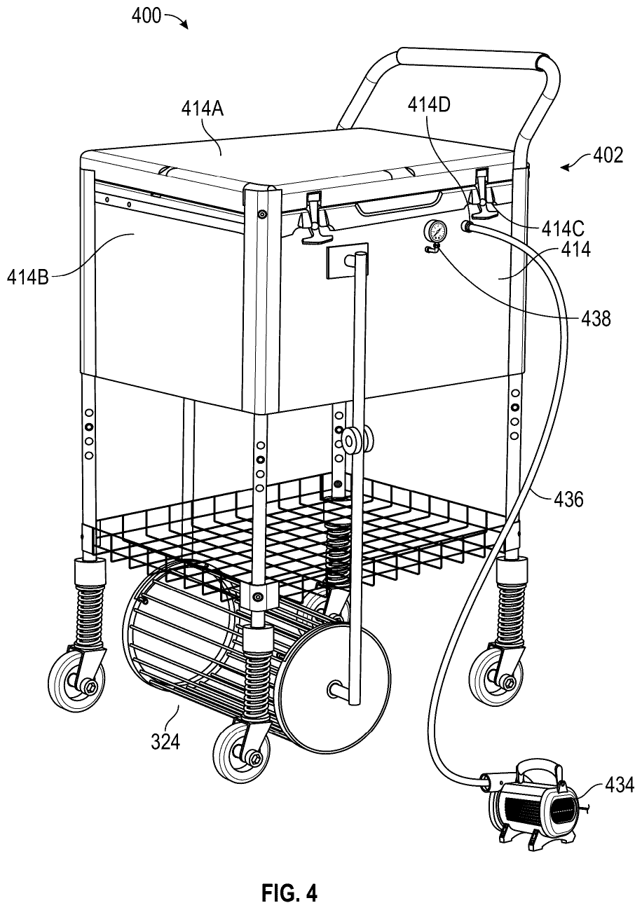

FIG. 4 is a perspective view of a ball cart system 400 having a ball collector, according to various embodiments. The ball cart system 400 includes a ball cart 402 with a ball collector that is the same or similar in many aspects to the cart 302 with ball collector 324 shown in FIG. 3.

As shown in FIG. 4, the cart 402 has a fully enclosed container 414. That is, instead of having a wire mesh construction or a plurality of openings, the container 414 has a plurality of solid walls 414B and is fully enclosed. The container 414 includes a lid 414A coupled with hinges to one of the solid walls 414B. The lid 414A can include one or more securing mechanisms 414C to keep the lid 414A closed.

The container 414 can be constructed to be substantially airtight. As used herein, a container 414 is “substantially airtight” if it is capable of maintaining air pressure inside the container greater than atmospheric pressure for at least 12 hours. The inside of lid 414A can include a seal or liner where the inside of lid 414A contacts the tops of the plurality of solids walls 414B when closed to provide a substantially airtight seal when closed. The ball cart system 400 can be connected to an air pump 434 via tube 436. The tube 436 is connected at one end of the air pump 434 and at an opposite end to a valve 414D assembled in one of the solid walls 414B of the container 414. Valve 414D can be a one-way valve that allows air to flow into the container 414 but not out of container 414. The air pump 434 is configured to pump air into the container 414 to increase air pressure within the container 414. The air pump 434 can be any type of air pump, including but not limited to a tire pump, ball pump, etc., that has sufficient air pumping capabilities to increase the air pressure inside the container to a pressure greater than atmospheric pressure. The container 414 may include a manometer 438 to measure pressure inside the container 414. The manometer 438 may indicate the pressure inside the container relative to the atmospheric pressure, for example. By increasing the air pressure within the container 414, the plurality of balls (not shown in FIG. 4) inside the container 414 are subjected to greater than atmospheric pressure. As a result, any pressurized balls inside the container 414 will be less susceptible to losing pressure over time when stored in container 414 as opposed to being stored in a standard ball cart.

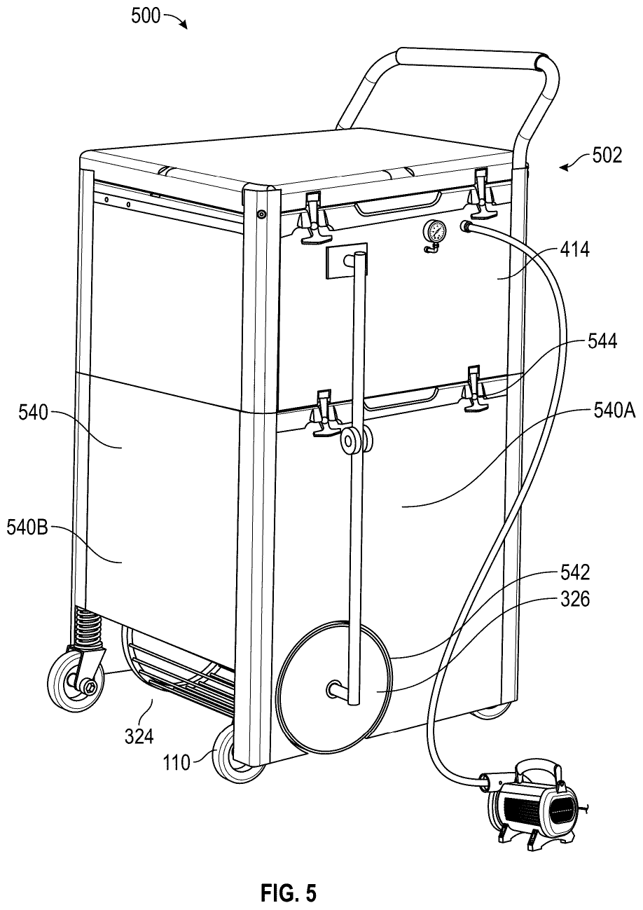

FIG. 5 is a perspective view of a ball cart system 500, according to various embodiments. The ball cart system 500 includes a ball cart 502 with a ball collector that is the same or similar in many aspects to the cart 402 with ball collector shown in FIG. 4.

The ball cart system 500 includes skirt walls 540 provided on a lower portion of the cart 502 below the container 414. Skirt walls 540 can be attached at their edges to support rods 106 (not shown because they are behind skirt walls 540). The rear and side skirt walls 540 extend down to the rollers 110. Side skirt walls 540A include an opening 542 to accommodate the ball collector 324. The opening 542 may be any size and shape but is shown in FIG. 5 to be a circle with a diameter slightly larger than the diameter of the cylindrical drum 326. Front skirt wall 540B does not extend down to the rollers 110 but instead leaves a sufficient space for balls to enter the ball collector 324 as the cart 502 is rolled along the ground surface by a user. The ball cart system 500 may include one or more securing mechanisms 544 to secure the container 414 to the side skirt walls 540A.

FIG. 6 is a perspective view of a ball cart system 600, according to various embodiments. The ball cart system 600 includes a cart 602 that is the same or similar in many aspects to the cart 302 shown in FIG. 3.

As shown in FIG. 6, the ball cart system 600 includes a ball collector 624 that is similar in many aspects to the ball collector 324 shown in FIG. 3. However, each side of ball collector 624 is connected to a support arm 650. A first connecting rod 650A and a second connecting rod 650B are connected to each other via a first rotating joint 650C. Second connecting rod 650B is further connected to a second rotating joint 650D, which in turn is coupled to the container 114 of cart 602. Ball collector 624 is shown in FIG. 6 with the door 326D (as described above with respect FIG. 1) in the cylindrical drum 326 in an open state but it should be appreciated that when the ball collector 624 is in operation the door 326D is in a closed state. The door 326D can be connected via hinges to the cylindrical drum 326. As shown in FIG. 6, the ball cart system 600 does not include a base 104 but could include a base 104 (as shown in FIG. 1) positioned behind connecting rods 650A to support ball collector 624.

In operation, a user can empty balls collected in the cylindrical drum 326 of the ball collector 624 by opening lid 114A if it is closed and then swinging the ball collector 624 up and away from the front end of cart 602. Supporting arms 650 rotate at rotating joints 650C and 650D to position the ball collector 624 above the container 114. A user then opens door 326D of cylindrical drum 326 to empty collected balls into container 114. The length of connecting rods 650A and/or connecting rods 650B can be adjustable, such as in a telescoping manner, to adjust the length of connecting rods 650A and/or connecting rods 650B to better position the ball collector 624 above the container 114.

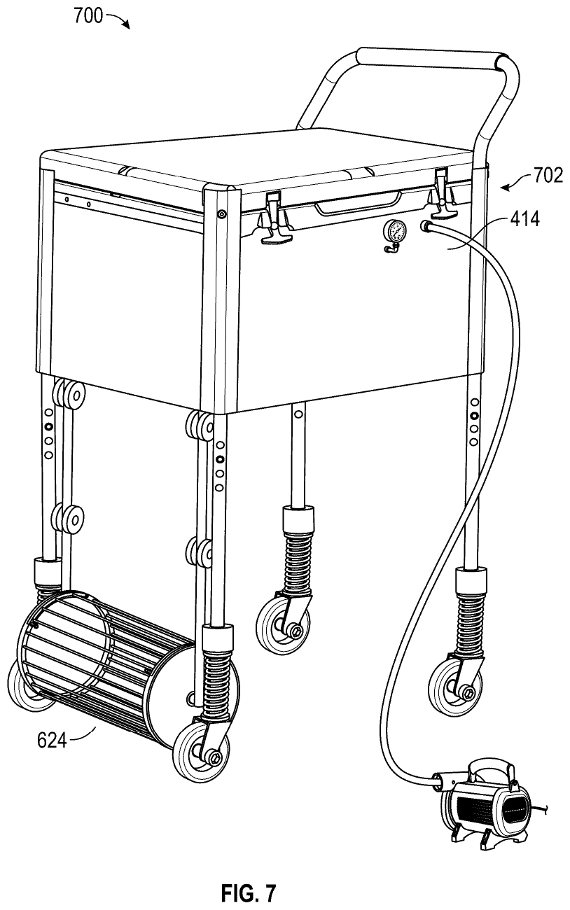

FIG. 7 is a perspective view of a ball cart system 700, according to various embodiments. The ball cart system 700 includes a cart 702 that combines, for example, features of the ball cart 402 shown in FIG. 4 and the ball collector 624 shown in FIG. 6. Specifically, the cart 702 includes container 414 and related components that enable the container 414 to be pressurized, as described above with respect to FIG. 4. The cart 702 also includes ball collector 624 and related components that enable ball collector 624 to swing up and away from the front end of cart 702 to empty balls into container 414, as described above with respect to FIG. 6.

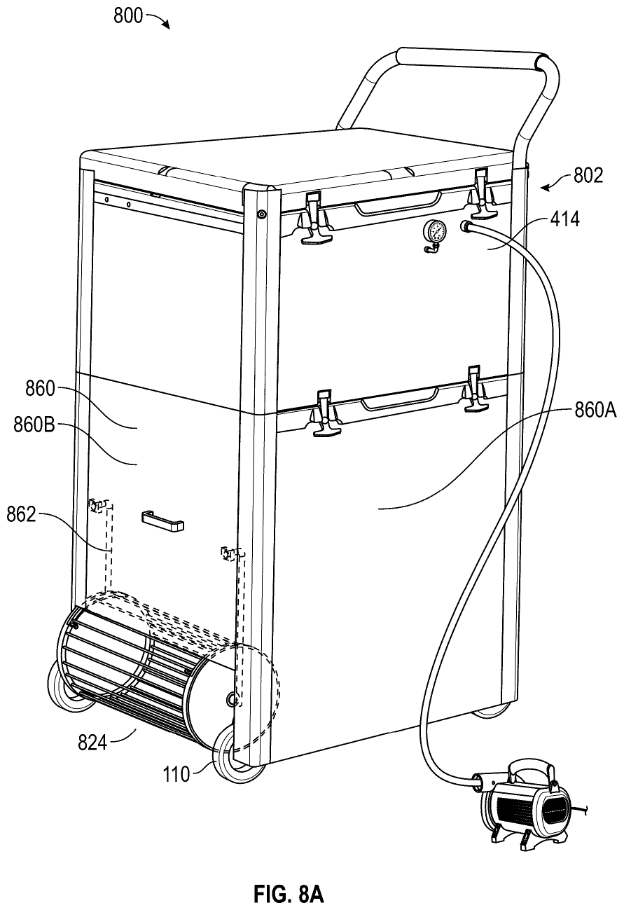

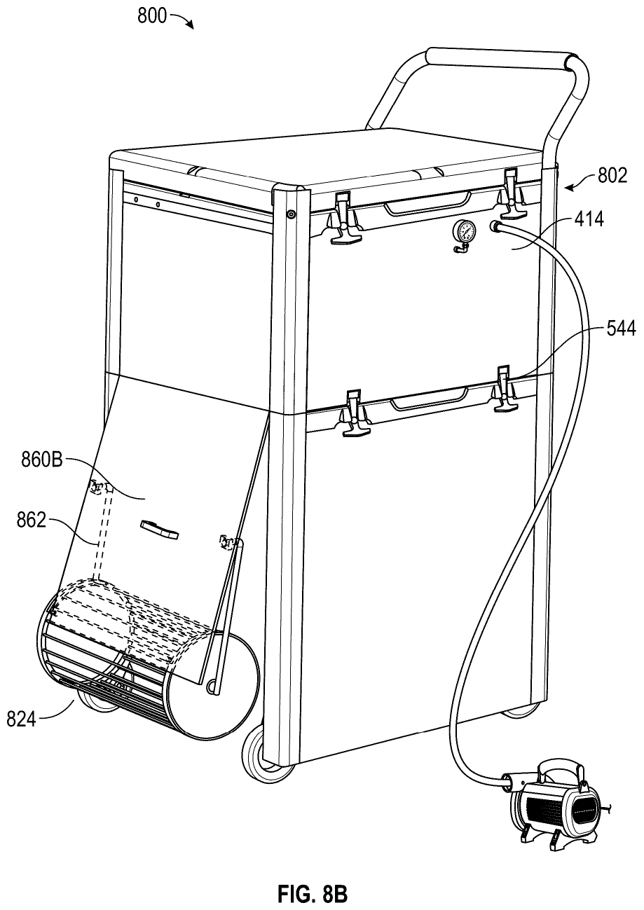

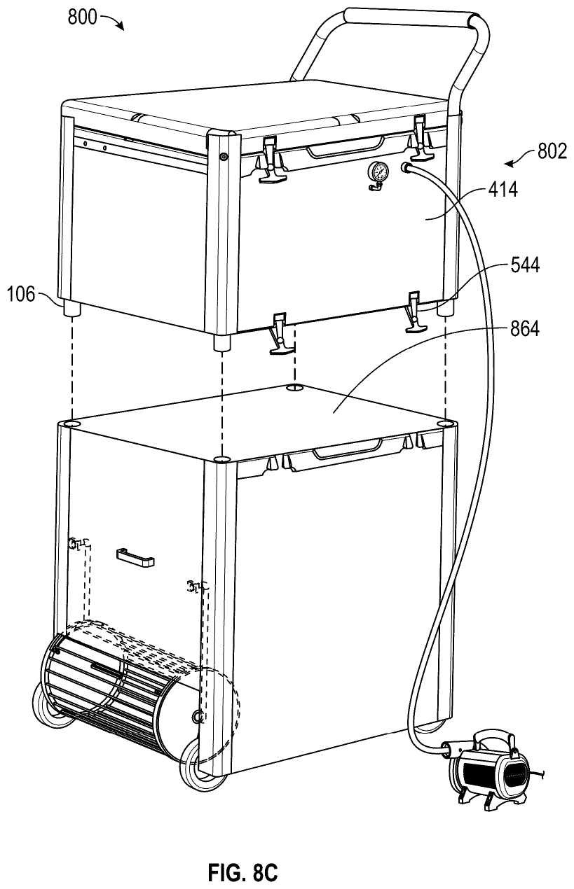

FIG. 8A is a perspective view of a ball cart system 800, according to various embodiments that contain the same or similar aspects as shown in previous figures. The ball cart system 800 includes container 414 and related components that enable container 414 to be pressurized, as described above with respect to FIG. 4. The ball cart system 800 includes skirt walls 860 provided on a lower portion of the cart 802 below the container 414. The rear and side skirt walls 860A extend down to the rollers 110. Front skirt wall 860B does not extend down to the rollers 110 but instead leaves a sufficient space for a ball collector 804 to be positioned below the front skirt wall 860B. Support arms 862 are coupled at one end to each side of the ball collector 824 and coupled on the other end to the inside of the front skirt wall 860B.

FIG. 8B is a perspective view of a ball cart system 800 having a movable front skirt wall, according to various embodiments. As shown in FIG. 8B, the front skirt wall 860B is coupled to the container 414 via hinges that allow the front skirt wall 860B to swing open. When the front skirt wall 860B is swung fully open, the ball collector 824, which is coupled to the inside of front skirt wall 860B, becomes positioned above the container 414, and a user can empty collected balls into the container 414. The length of support arms 862 can be adjustable, such as in a telescoping manner, to adjust the length of support arms 862 to better position the ball collector 804 above the container 414.

FIG. 8C is a perspective view of a ball cart system 800 having a removable container 414, according to various embodiments. As shown in FIG. 8C, support rods 106 can have sections that detach from each other, and the container 414 can be removed from a bottom portion of cart 802 by releasing securing mechanisms 544. As also shown in FIG. 8C, a supporting platform 864 can be provided to support container 414 when placed back onto the bottom portion of cart 802.

The ball cart systems of this disclosure may include various accessories, such as a cell phone holder, a cupholder, a flashlight, audio speakers, an umbrella, or the like. For example, in reference to FIG. 1, a Bluetooth speaker can be attached via clips or by one or more fasteners to handlebar 116, support rods 106, or container 114 to allow an operator to play her favorite music. As another example, an umbrella can be attached via clips or by one or more fasteners to handlebar 116, support rods 106, or container 114 to provide shade to the user.

Only exemplary embodiments of the disclosure and but a few examples of its versatility are shown and described in this disclosure. It is to be understood that the invention is capable of use in various other combinations and environments and is capable of changes or modifications within the scope of the inventive concept as expressed herein.

Although the foregoing description is directed to the preferred embodiments of the invention, it is noted that other variations and modifications will be apparent to those skilled in the art and may be made without departing from the spirit or scope of the invention. Moreover, features described in connection with one embodiment of the invention may be used in conjunction with other embodiments, even if not explicitly stated above.

1. A ball cart system, comprising:
a cart comprising:
a plurality of support rods;
a container mounted to the plurality of support rods, the plurality of support rods being configured to support the container;
a plurality of springs, at least one spring of the plurality of springs being coupled to an end of one of the plurality of support rods;
a plurality of rollers, at least one roller of the plurality of rollers being coupled to at least one spring of the plurality of springs; and
a ball collector comprising a cylindrical drum,
wherein the container is substantially airtight, and
wherein each spring of the plurality of springs is configured to compress or decompress according to a vertical force applied onto it by a weight within the container, and as the weight within the container changes, a height of the container relative to a ground automatically adjusts.

2. The ball cart system according to claim 1, wherein each of the plurality of support rods includes one or more height adjusting features.

3. The ball cart system according to claim 2, wherein at least one of the height adjusting features comprises a push button mechanism.

4. The ball cart system according to claim 1, wherein a spring rate of said each spring is independently adjustable.

5. The ball cart system according to claim 1, wherein the cart further comprises a base connected to the plurality of support rods.

6. The ball cart system according to claim 1, wherein the cart further comprises a handlebar.

7. The ball cart system according to claim 1, wherein at least one roller of the plurality of rollers has a locking mechanism to prevent the at least one roller from rolling.

8. The ball cart system according to claim 1, wherein the container includes a valve, the valve being configured to be connected to an air pump.

9. The ball cart system according to claim 1, wherein the container includes a manometer.

10. The ball cart system according to claim 1, wherein the cylindrical drum comprises a door.

11. The ball cart system according to claim 1, wherein the cart comprises a top portion and a bottom portion, and wherein the plurality of support rods have sections configured to detach from each other so as to enable removal of the container from the bottom portion of the cart.

12. A ball cart system, comprising:
a cart comprising:
a plurality of support rods;
a container mounted to the plurality of support rods, the plurality of support rods being configured to support the container;
a plurality of rollers, at least one roller of the plurality of rollers being coupled to at least one support rod of the plurality of support rods;
a plurality of springs positioned at a bottom of the container; and
a movable platform provided inside the container and supported by the plurality of springs,
a ball collector comprising a cylindrical drum,
wherein the container is substantially airtight,
wherein the plurality of springs are configured to compress or decompress according to a vertical force applied onto the movable platform, and as the vertical force applied onto the movable platform changes, a height of the movable platform relative to a ground automatically adjusts.

13. The ball cart system according to claim 12, wherein each of the plurality of support rods includes one or more height adjusting features.

14. The ball cart system according to claim 13, wherein at least one of the height adjusting features comprises a push button mechanism.

15. The ball cart system according to claim 12, wherein a spring rate of said each spring is independently adjustable.

16. The ball cart system according to claim 12, wherein the cart further comprises a base connected to the plurality of support rods.

17. The ball cart system according to claim 12, wherein the cart further comprises a handlebar.

18. The ball cart system according to claim 12, wherein at least one roller has a locking mechanism to prevent the roller from rolling.

19. The ball cart system according to claim 12, wherein the cylindrical drum comprises a door.

20. The ball cart system according to claim 12, wherein the cart has a top portion and a bottom portion, and wherein the plurality of support rods have sections configured to detach from each other so as to enable removal of the container from the bottom portion of the cart.
